(19) United States
(12) Patent Application Publication
(10) Pub. No.: US 2006/0057252 A1
(43) Pub. Date: Mar. 16, 2006

(54) Composition containing calcium pantothenate and vitamin

(75) Inventors: Hiroshi Morimoto, Takaoka-shi (JP); Taizo Yamatani, Takaoka-shi (JP); James E. Nocek, Auburn, NY (US)

Correspondence Address: GREENBLUM & BERNSTEIN, P.L.C., 1950 ROLAND CLARKE PLACE, RESTON, VA, 20191, US

(73) Assignee: DAIICHI FINE CHEMICAL CO., LTD., Toyama (JP)

(21) Appl. No.: 11/129,352

(22) Filed: May 16, 2005

(30) Foreign Application Priority Data
May 17, 2004 (JP) 2004-146052

(51) Int. Cl. A23L 1/30

(52) U.S. Cl. 426/72

(57) ABSTRACT

A composition containing calcium pantothenate and at least one kind of vitamin as a mixture of solid state, wherein the calcium pantothenate is crystalline calcium pantothenate obtainable by a method comprising the following steps: (1) the step of mixing crystalline calcium pantothenate and amorphous calcium pantothenate to prepare a homogenous mixture; (2) the step of allowing the homogenous mixture obtained in the aforementioned step (1) to absorb moisture to prepare crystalline calcium pantothenate; and (3) the step of repeating the aforementioned steps (1) and (2) by using the crystalline calcium pantothenate obtained in the aforementioned step (2), and having a ratio (I^{16.0}/I^{5.1}) of the diffraction intensity I^{16.0} at an diffraction angle (2 θ) of 16° relative to the diffraction intensity I^{5.1} at an diffraction angle (2 θ) of 5.1° of 1 or more in a powder X-ray diffraction pattern.

### TECHNICAL FIELD

The present invention relates to a stable composition containing crystalline calcium pantothenate and a vitamin.

### BACKGROUND ART

Calcium pantothenate (monocalcium bis [(R)-N-(2,4-dihydroxy-3,3-dimethyl-butyryl)-β-alaninate], hereinafter occasionally abbreviated as “PC”) is a medicament listed in the Japanese Pharmacopoeia and widely used for prophylactic and therapeutic treatment of pantothenic acid deficiency as well as therapeutic treatment of contact dermatitis, acute and chronic eczema and the like. As solid powder of calcium pantothenate, amorphous form products are known. However, these products have a problem that the powder solidifies by absorbing moisture because of hygroscopic property, and careful handling is required for manufacture, storage, transportation, and use thereof. As crystalline-type solid powder, α, β- and γ-forms as non-solvate crystals, and 4CH₃OH.1H₂O addition crystals and monohydrate crystals as solvent addition crystals are known (as for details of these crystalline forms, see, Inagaki et al., Chem. Pharm. Bull., 24, pp. 3097-3102, 1976). It is known that these crystalline-type PCs are nonhygroscopic.

For manufacture of crystalline calcium pantothenate, methods having been proposed include a method comprising the steps of crystallizing PC from an organic solvent such as methanol, dissolving the resulting crystals in water, concentrating the resulting solution, and then adding methanol and heating the mixture to obtain nonhygroscopic needles (m.p. 195-196° C.) (Levy, H. et al., J. Amer. Chem. Soc., 63, pp. 2846-2847, 1941); a method for obtaining crystals from a methanol solution which are different from those obtained by the aforementioned method of Levy et al. (m.p. 153.5-154° C.) (Funabashi et al., Bull. Inst. Phys. Chem. Research (Japan), 22, 681, 1943); a method comprising the step of adding an appropriate amount of water to a methanol solution to deposit crystals (Japanese Patent Publication (KOKOKU) No. Sho. 40-2330/1965); a method of depositing an optically active product from a water-containing methanol solution (Japanese Patent Publication (KOKOKU) No. Sho. 49-27168/1974); a method of collecting PC from a methanol solution (Japanese Patent Unexamined Publication (KOKAI) No. Sho. 53-108921/1978); a method of preparing a composition using magnesium lactate and the like (Japanese Patent Unexamined Publication No. (KOKAI) Hei 3-123729/1991); a method comprising the step of collecting PC from a fermented solution wherein methanol is added to an aqueous solution of PC in a high concentration of about 50 W/V % to adjust a methanol concentration to 90 V/V % (Japanese Patent Unexamined Publication No. (KOKAI) Hei 9-286/1997); and a method for preparing PC by using a transformant wherein methanol is added to a PC solution in a high concentration of about 45 to 55 W/W % (Japanese Patent Unexamined Publication No. (KOKAI) Hei 9-135687/1997). A method of producing nonhygroscopic crystalline calcium pantothenate using substantially no organic solvent by allowing a homogenous mixture containing crystalline calcium pantothenate and amorphous calcium pantothenate to absorb moisture is also known (International Patent Publication WO01/98255).

It is known that mixing of calcium pantothenate with a vitamin promotes degradation of calcium pantothenate and the vitamin. In particular, if calcium pantothenate is mixed with a water-soluble vitamin (ascorbic acid, vitamin B₆, vitamin B₁, vitamin B₂, nicotinamide and the like), both calcium pantothenate and the water-soluble vitamin will suffer from significant degradation. For a composition containing calcium pantothenate and a vitamin, several proposals have been made for improving stability of these components. For example, a solid preparation comprising ascorbic acid and a calcium pantothenate composition (containing lactate or carbonate of magnesium or calcium) is disclosed in Japanese Patent Unexamined Publication No. 2003-128543. Further, in order to enhance stability of a vitamin in the composition, for example, means of using an auxiliary agent such as polyhydric alcohols and hydrophilic nonionic surfactants have also been proposed. However, the addition of a component for the stabilization is essential in these methods, which results in a problem that a content of calcium pantothenate per unit weight will decrease and thus the preparations become bulky.

Another problem arises for the powders of amorphous calcium pantothenate in that they aggregate when added to water to form hardly soluble masses, which results in undesirably long period of time for dissolution. In order to avoid this problem, it is desired to provide calcium pantothenate having a property of achieving quick and fine dispersion when added in water to give a homogenous aqueous solution in a short time.

Furthermore, amorphous calcium pantothenate with poor dispersibility has a problem that it causes blocking to give agglomeration due to the poor dispersibility when homogenously mixed in animal feed, which may cause a serious problem when a small amount of calcium pantothenate is mixed in animal feed. Moreover, a large amount of vitamins are often blended in animal feed, and accordingly, reduced stability of calcium pantothenate to be added is also a problem. This problem is very serious when a small amount of calcium pantothenate is homogenously mixed in animal feed.

### DISCLOSURE OF THE INVENTION

An object of the present invention is to provide a stable composition containing calcium pantothenate and a vitamin. Another object of the present invention is to provide a method for efficiently preparing an aqueous solution containing calcium pantothenate. A further object of the present invention is to provide feed for animals in the form of a composition homogenously mixed with calcium pantothenate and a vitamin.

The inventors of the present invention found that novel crystalline calcium pantothenate was successfully producible by preparing crystalline calcium pantothenate by allowing a homogenous mixture containing crystalline calcium pantothenate and amorphous calcium pantothenate to absorb moisture according to the method described in International Publication W001/98255 to prepare crystalline calcium pantothenate, and then adding amorphous calcium pantothenate again to the resulting crystals to form a homogenous mixture, followed by allowing the mixture to absorb moisture to prepare crystalline calcium pantothenate, and further repeating the same steps plural times by using the resulting crystalline calcium pantothenate. The crystalline calcium pantothenate obtained has a feature that diffraction angles (2 θ) of major peaks observed in powder X-ray diffraction analysis are identical to those of known β-form crystals, provided that the intensities of peaks at 2θ of 5.1° and 16.0° are in the reverse order relative to those of known β-form crystals.

The inventors of the present invention conducted various researches on formulations comprising the novel crystalline calcium pantothenate, and they found during the course of researches that, in a composition in which the novel crystalline calcium pantothenate and a vitamin are mixed in a solid state, degradation of the calcium pantothenate and the vitamin was remarkably suppressed compared with a composition prepared by using amorphous calcium pantothenate, and by using the aforementioned crystalline calcium pantothenate, an aqueous solution was far more efficiently prepared than a solution prepared using amorphous calcium pantothenate. The inventors of the present invention further found that, by using the aforementioned novel crystalline calcium pantothenate, masses were not formed and feed was very easily obtainable when a small amount of calcium pantothenate is homogenously mixed in animal feed, and even when a vitamin was mixed in the feed, stability of the vitamin and calcium pantothenate were not reduced. The present invention was achieved on the basis of these findings.

The present invention thus provides a composition containing calcium pantothenate and at least one kind of vitamin as a mixture in a solid state, wherein the calcium pantothenate is crystalline calcium pantothenate obtainable by a method comprising the following steps:
(1) the step of mixing crystalline calcium pantothenate and amorphous calcium pantothenate to prepare a homogenous mixture;
(2) the step of allowing the homogenous mixture obtained in the aforementioned step (1) to absorb moisture to prepare crystalline calcium pantothenate; and
(3) the step of repeating the aforementioned steps (1) and (2) by using the crystalline calcium pantothenate obtained in the aforementioned step (2).

The aforementioned crystalline calcium pantothenate has peaks in a powder X-ray diffraction spectrum at the positions of diffraction angles (2 θ) of 5.1°, 10.3°, 11.9°, 16.0°, and 18.9°, and a ratio of the diffraction intensity at an diffraction angle (2θ) of 5.1° relative to the diffraction intensity at an diffraction angle (2 θ) of 16° is 1 or more, preferably in the range of 1 to 3, more preferably in the range of 1.5 to 2.5.

According to preferred embodiments, the present invention provides the aforementioned composition, which is selected from the group consisting of a pharmaceutical composition, processed food, animal feed, and cosmetic composition; the aforementioned composition, wherein the vitamin is a water-soluble vitamin; and the aforementioned composition, wherein the water-soluble vitamin is ascorbic acid. The present invention also provides use of the aforementioned crystalline calcium pantothenate for manufacture of the aforementioned composition. Furthermore, the present invention provides a method for enhancing stability of calcium pantothenate and/or a vitamin in a composition containing calcium pantothenate and at least one kind of vitamin as a mixture in a solid state, wherein the aforementioned crystalline calcium pantothenate is used as the calcium pantothenate.

From another aspect, the present invention provides a method for preparing an aqueous solution of calcium pantothenate by adding an aqueous medium to solid calcium pantothenate in a dry state, wherein the calcium pantothenate is the aforementioned crystalline calcium pantothenate.

From still further aspects, the present invention provides feed for animals containing the aforementioned crystalline calcium pantothenate and a vitamin in a homogenously mixed state; a method for producing feed for animals, which comprises the step of homogenously mixing the aforementioned crystalline calcium pantothenate in feed for animals containing a vitamin, and a method for producing feed for animals, which comprises the step of homogenously mixing a vitamin and the aforementioned crystalline calcium pantothenate in feed for animals. The present invention also provides use of the aforementioned crystalline calcium pantothenate for manufacture of the aforementioned feed for animals; and feed for breeding bovines, which contains the aforementioned crystalline calcium pantothenate and a vitamin in a homogenously mixed state, and can increase amount of production milk fat and proteins and/or shorten period of days up to pregnancy.

In the composition of the present invention, stability of calcium pantothenate and vitamin is remarkably improved. Therefore, even after storage for a long period of time or a process of distribution, a decrease in the contents of the aforementioned active ingredients is reduced. Moreover, when an aqueous solution is prepared by using calcium pantothenate, efficiently preparation of the aqueous solution can be achieved according to the method of the present invention.

The feed for animals provided by the present invention can be easily produced without formation of masses by using a small amount of calcium pantothenate when the calcium pantothenate is added and homogenously mixed. Moreover, by using the feed for animals of the present invention, which contains an appropriate small amount of calcium pantothenate, efficiency of dairy cow production can be markedly improved, for example, amounts of production of milk fat and proteins can be increased and days reaching to pregnancy can be shortened.

### BRIEF EXPLANATION OF THE DRAWINGS

FIG. 1 shows a powder X-ray diffraction pattern of the β-form crystals produced in Reference Example 1.

FIG. 2 shows an electron micrograph of the β-form crystals produced in Reference Example 1.

FIG. 3 shows an electron micrograph (enlarged) of the β-form crystals produced in Reference Example 1.

FIG. 4 shows a powder X-ray diffraction pattern of the β-form crystals produced in Reference Example 2.

FIG. 5 shows an electron micrograph of the β-form crystals produced in Reference Example 2.

FIG. 6 shows an electron micrograph (enlarged) of the β-form crystals produced in Example 2.

FIG. 7 shows changes in powder X-ray diffraction patterns of the products during the repetition of the steps in Reference Example 4. In the drawings, (A) represents the powder X-ray diffraction pattern of the β-form crystals used as seed crystals; (B) represents the powder X-ray diffraction pattern of the product after the first repetition; and (C) represents the powder X-ray diffraction pattern of the product after the second repetition.

FIG. 8 shows change in powder X-ray diffraction patterns of the products during the repetition of the steps in Reference Example 4. In the drawing, (D) represents the powder X-ray diffraction pattern of the product after the third repetition; (E) represents the powder X-ray diffraction pattern of the product after the fourth repetition; and (F) represents the powder X-ray diffraction pattern of the product after the eighth repetition.

FIG. 9 shows an electron micrograph of the crystalline calcium pantothenate produced in Reference Example 4.

FIG. 10 shows an electron micrograph (enlarged) of the crystalline calcium pantothenate produced in Reference Example 4.

FIG. 11 shows an electron micrograph of the amorphous powder produced in Reference Example 2.

FIG. 12 shows an electron micrograph (enlarged) of the amorphous powder produced in Reference Example 2.

FIG. 13 shows the results of the dissolution test using the crystalline calcium pantothenate obtained in Reference Example 4 and the amorphous calcium pantothenate obtained in Reference Example 2.

### BEST MODE FOR CARRYING OUT THE INVENTION

The term “crystalline” used in the specification encompasses a substance containing a small amount of an amorphous part, as well as a substance substantially consisting completely of crystals. However, calcium pantothenate in a completely amorphous state (the state which gives substantially no detectable peak by the powder X-ray diffraction analysis) is excluded. The term “crystalline” should not be interpreted to exclude a substance containing a small amount of an amorphous part. Further, the term “amorphous” means a state in which no peak is substantially detectable by powder X-ray diffraction analysis.

The crystalline calcium pantothenate contained in the composition of the present invention is a novel substance that can be obtained by a method comprising the following steps:
(1) the step of mixing crystalline calcium pantothenate and amorphous calcium pantothenate to prepare a homogenous mixture;
(2) the step of allowing the homogenous mixture obtained in the aforementioned step (1) to absorb moisture to prepare crystalline calcium pantothenate; and
(3) the step of repeating the aforementioned steps (1) and (2) by using the crystalline calcium pantothenate obtained in the aforementioned step (2).

The aforementioned steps (1) and (2) are described in International Patent Publication WO01/98255, and can be performed according to the method specifically described in the above publication. The entire disclosure of International Patent Publication WO01/98255 is incorporated into the disclosure of the present specification by reference.

The aforementioned step (1) is a step of producing a homogenous mixture containing crystalline calcium pantothenate and amorphous calcium pantothenate by mixing crystalline calcium pantothenate and amorphous calcium pantothenate. As the crystalline calcium pantothenate, it is preferable to use nonhygroscopic crystalline calcium pantothenate. For example, nonhygroscopic β-form crystals (in the specification, the “β-form crystal” means the β-form crystal described in Chem. Pharm. Bull., 24, pp. 3097-3102, 1976) can be used. Other than the β-form crystal, a mixture containing the α-form crystal, γ-form crystal, monohydrate crystal, or the like, or crystalline calcium pantothenate other than the β-form crystal can also be used. The method for preparing amorphous calcium pantothenate used as a starting material is not particularly limited. For example, preferably used amorphouses include those obtained by a method comprising the steps of spraying an aqueous solution of calcium pantothenate and drying the sprayed solution with hot air to prepare amorphous powder or a method comprising the steps of crystallizing calcium pantothenate from a methanol solution, collecting the crystals by filtration and drying the crystals with hot air to prepare amorphous powder of calcium pantothenate.

The calcium pantothenate used as a starting material desirably has a purification degree as high as possible. For example, calcium pantothenate prepared by a synthetic method, a method comprising fermentation, or a method applied by a gene recombination technique and the like may be used. The calcium pantothenate may be purified by recrystallization or a conventional purification means to prepare crystalline calcium pantothenate or amorphous calcium pantothenate.

The method for mixing crystalline calcium pantothenate and amorphous calcium pantothenate is not particularly limited. It is usually desirable to prepare a homogenous mixture by mechanically mixing crystalline calcium pantothenate and amorphous calcium pantothenate prepared as powder. Particle size of powdery crystalline calcium pantothenate or amorphous calcium pantothenate used as a raw material is not particularly limited. For example, the particle size is about 20 to 500 μm. The preparation of homogenous mixture can be carried out by a method widely used in the field or art as means for mixing solid, preferably powder.

A temperature and humidity at the preparation of the homogenous mixture are not particularly limited. For example, the mixing may be carried out at room temperature under ordinary humidity, for example, 40 to 80% RH (% RH represents relative humidity, the same shall apply hereinafter). It is also possible to prepare the homogenous mixture under appropriate warming and humidification conditions, thereby the second step can be performed simultaneously. Mixing ratio of crystalline calcium pantothenate and amorphous calcium pantothenate is not particularly limited, and the ratio can be suitably chosen by those skilled in the art depending on the moisture absorption conditions in the subsequent step, desired form of crystalline calcium pantothenate and the like. In general, 10% by weight or more, preferably about 30% by weight, of crystalline calcium pantothenate may be used based on the total weight of the homogenous mixture.

The aforementioned step (2) is a step of allowing the homogenous mixture of crystalline calcium pantothenate and amorphous calcium pantothenate obtained in the above step to absorb moisture. In general, this moisture absorption step can be carried out by leaving the aforementioned homogenous mixture standing under appropriate temperature and humidity, or stirring the homogenous mixture under appropriate temperature and humidity. The step is carried out under temperature and humidity sufficient for crystallization of amorphous calcium pantothenate into nonhygroscopic crystalline calcium pantothenate. Such temperature and humidity can be readily determined by those skilled in the art depending on, for example, type of the homogenous mixture, form of the desired nonhygroscopic calcium pantothenate and the like by performing a test similar to that described in International Patent Publication W001/98255, section of examples, Example 8. For example, a suitable combination of a temperature of from room temperature to about 80° C. and humidity of about 30 to 90% RH, preferably about 40 to 80% RH, can be chosen.

Means for performing the mixing used for the moisture absorption is not particularly limited, and an ordinary mechanical stirring apparatus can be used. In order to efficiently prepare the target product in an industrial scale, stirring is generally indispensable. The term “stirring” used in the present specification should be interpreted as its broadest meaning including common stirring operations, as well as means capable of achieving physical effect similar to the stirring (e.g., vibrations, fluidization, ultrasonic stirring and the like). The nonhygroscopic crystalline calcium pantothenate obtained in the aforementioned step (2) preferably substantially consists of nonhygroscopic crystalline calcium pantothenate, and preferably prepared as a crystalline substance that does not substantially contain an amorphous part. It is preferred that the β-form crystal is obtained in the step (2), although nonhygroscopic crystalline calcium pantothenate may sometimes be obtained which contains a form of crystalline calcium pantothenate different from that of the crystalline calcium pantothenate used for the preparation of the homogenous mixture. The crystalline calcium pantothenate obtained in the aforementioned step (2) may be used as the starting material for the step (3) without any treatment such as drying, or used as the starting material for the step (3) after subjected to drying as required. The means for drying is not particularly limited, and the drying can be performed by using a dryer available in the field under appropriate conditions.

The aforementioned step (3) is a step of repeating the aforementioned steps (1) and (2) by using the crystalline calcium pantothenate obtained in the aforementioned step (2) as a starting material. This step can be performed in the same manner as the methods explained above. The number of repetition is not particularly limited. The repetition is at least once, preferably twice or more, more preferably 5 times or more, particularly preferably 8 times or more. Although the maximum number of repetition is not particularly limited, the repetition may be about 10 times or less from a viewpoint of industrial production cost, because flowability improving effect may be reduced when the repetition exceeds 10 times.

The crystalline calcium pantothenate obtained by the aforementioned method is characterized by having a characteristic peak pattern in the powder X-ray diffraction spectrum. This crystalline calcium pantothenate has peaks in powder X-ray diffraction spectrum at the positions of diffraction angles (2 θ) of 5.1°, 10.3°, 11.9°, 16.0° and 18.9°, and among these peaks, the ratio (I^{16.0}/I^{5.1}) of the diffraction intensity I^{16.0} at a diffraction angle (2 θ) of 16.0° relative to a diffraction intensity I^{5.1} at a diffraction angle (2θ) of 5.1° is 1 or larger, preferably in the range of from 1 to 3 (ranges of numerical values defined by using “from—to” in the specification are those including numerical values at the lower and upper limits), more preferably in the range of 1.5 to 2.5.

The “β-form crystal” is already known (Chem. Pharm. Bull., 24, pp. 3097-3102, 1976), and the ratio (I^{16.0}/I^{5.1}) of the diffraction intensity I^{16.0} at a diffraction angle (2θ) of 16.0° relative to a diffraction intensity I^{5.1} at a diffraction angle (2 θ) of 5.1° of said crystal is less than 1, thereby said crystal can be definitely distinguished from the crystalline calcium pantothenate obtained by the aforementioned method. The values of the diffraction angles 2 θ in powder X-ray diffraction measurement are angles observed by using K a characteristic X-ray of copper ordinarily used, and precision of the angles is about ±0.1°. Moreover, the β-form crystalline calcium pantothenate obtained by crystallization is in the form of needle, whereas the crystalline calcium pantothenate obtained by the aforementioned method differs from the aforementioned β-form crystal also in appearance, and is similar to that of pantothenate in an amorphous form.

Although the desired crystalline calcium pantothenate can be obtained by the aforementioned step (3) without particular treatments such as drying, the resulting crystalline calcium pantothenate may be optionally subjected to a treatment of drying, granulation or the like, as required, after the aforementioned step (3). The means for drying is not particularly limited, and the drying can be performed by using a dryer available in this field under appropriate conditions.

The composition of the present invention contains the aforementioned crystalline calcium pantothenate obtained by the aforementioned method and at least one kind of vitamin as a mixture in a solid state. The mixture in a solid state means a mixture in which the aforementioned crystalline calcium pantothenate and the vitamin each in the form of dry powder, granule or the like exist in a state that they are in contact with each other. In the composition of the present invention, stabilities of calcium pantothenate and vitamin are improved, and a decrease of an amount of content of each ingredient is reduced even after long term storage.

Uses of the composition of the present invention are not particularly limited, and preferably, the composition may be, for example, a pharmaceutical composition, cosmetic composition, processed food, animal feed or the like. The pharmaceutical composition includes pharmaceutical compositions used for prophylaxis, diagnosis, and therapeutic treatment of diseases of humans, and also includes what is called quasi drugs, pharmaceutical compositions used for diseases of mammals other than human, and the like. Examples of the pharmaceutical composition include, for example, powders, granules, subtilized granules, tablets (e.g., plain tablets, film coated tablets, thin layer sugar-coated tablets, sugar-coated tablets, chewable tablets, bilayer tablets, and the like), capsules, powder inhalants, before use dissolution type injections provided in a dry powder form, and the like. Examples of the cosmetic composition include, for example, powders, foundations, and the like. However, these specific compositions are described as examples, and the compositions are not limited to these examples.

As the vitamin, either a water-soluble vitamin or a lipid-soluble vitamin may be used. Examples of the water-soluble vitamin include, for example, nicotinic acid, nicotinamide, thiamine (vitamin B₁), salts and derivatives thereof, riboflavin (vitamin B₂), salts and derivatives thereof, pyridoxine (vitamin B₆), salts and derivatives thereof, D-pantothenyl alcohol, pantothenyl ethyl ether, acetylpantothenyl ethyl ether, ascorbic acid (vitamin C), salts and derivatives thereof, folic acid, biotin, vitamin B₁₂, lipoic acid, inositol, choline chloride, and the like. Examples of the lipid-soluble vitamin include, for example, retinol and derivatives thereof, vitamin E and derivatives thereof, vitamin P and derivatives thereof, vitamin K and derivatives thereof, and the like. As the vitamin, water-soluble vitamins are preferred, and one or more kinds vitamins selected from the group consisting of ascorbic acid, pyridoxine hydrochloride, nicotinamide, thiamin hydrochloride and riboflavin are preferred. As the vitamin, two or more vitamins may be used in combination.

In the composition of the present invention, a ratio of the crystalline calcium pantothenate produced by the aforementioned method and the vitamin is not particularly limited. The ratio may be, for example, about 0.01 to 10, preferably about 0.05 to 2, in terms of weight ratio.

The composition of the present invention may contain one or more kinds of components other than the aforementioned crystalline calcium pantothenate and vitamin. The composition of the present invention may be compacted in any shape by a suitable means such as granulation. The compacted product such as granules obtained by the above method may further be mixed with one or more kinds of ingredients to prepare another type of composition. The ingredients used for the above purpose can be suitably chosen by those skilled in the art depending on an intended use of the composition of the present invention, and types thereof are not particularly limited. For example, where the composition is a pharmaceutical composition, ordinarily used pharmaceutical additives (for example, excipients and the like) can be used, where the composition is a cosmetic, additives for cosmetics can be used, and where the composition is processed food, food additives and the like can be used.

Examples of the aforementioned ingrediemtns include, for example, physiologically active substances such as amino acids, lipids, saccharides, hormones, enzymes and nucleic acids, breast meat of a chicken, wheat flour, rice bran, and the like. The composition may be contain, as a binder, for example, hydroxypropylcellulose, hydroxymethylcellulose, hydroxymethylpropylcellulose, polyvinylpyrrolidone, polyvinyl alcohol, dextrin, pullulan, pregelatinized starch, gelatinized starch, gum arabic, gelatin, cellulose acetate phthalate, hydroxypropylmethylcellulose phthalate, ethylcellulose, L-arabinose, D-xylose, D-2-deoxyribose, D-ribose, D- and L-galactose, D-glucose, D-mannose, D-fructose, L-sorbose, L-fucose, L-rhamnose, D-glucosamine, D-sorbitol, D-mannitol, galactitol, erythritol, cellobiose, gentibiose, isomaltose, kojibiose, lactose, lactitol, laminaribiose, maltose, melibiose, nigerose, sophorose, sucrose, paratinose, trehalose, palatinitt, dextrin, stearic aicd and derivatives thereof, sucrose fatty acid esters, maize starch, Aspartame, stevia, acesulfame, saccharin, aminoalkyl methacrylate copolymers, methacrylic acid copolymers, carboxyvinyl polymers, polyvinylacetal diethylamine acetate, lactose, xylitol, maltitol, powdery reducing sugar starch syrup, arabitol, ribitol, glucitol, corn flour, wheat flour, rice bran, cottonseed meal, sodium arginate, carragheenan, casein, gluten, curdlan, guar gum, and the like.

The composition may also contain, as an inorganic salt, sodium chloride, manganese carbonate, zinc sulfate, iron sulfate, heme iron, ferritin, ferric phosphate, ferrous succinate, ferrous fumarate, iron lactate, ferric pyrophosphate, ferrous pyrophosphate, iron sesquioxide, ferric citrate, sodium ferrous citrate, ferric ammonium citrate, ferrous gluconate, ferric chloride, zinc acetate, zinc gluconate, zinc oxide, zinc chloride, selenium sulfide, copper gluconate, copper sulfate, copper chloride, manganese sulfate, manganese glycerophosphate, manganese chloride, manganese hypophosphite, manganese gluconate, magnesium silicate, magnesium oxide, magnesium stearate, magnesium chloride, magnesium carbonate, magnesium sulfate, magnesium gluconate, magnesium salicylate, magnesium hydroxide, magnesium acetate, magnesium(II) phosphate, magnesium(III) phosphate, calcium magnesium carbonate, bovine bone meal, fishbone powder, scallop shell powder, oyster shell powder, ground shell, egg shell powder, milk serum calcium, calcium gluconate, calcium carbonate, dibasic calcium phosphate, potassium sulfate, potassium iodide, and the like. The composition may further contain, as an aromatic, for example, peppermint oil, eucalyptus oil, cinnamon oil, fennel oil, clove oil, orange oil, lemon oil, rose oil, fruit flavor, banana flavor, strawberry flavor, mint flavor, peppermint flavor, d1-menthol, 1-menthol, and the like. The composition may contain, as a flavoring agent, citric acid, malic acid, tartaric acid, ascorbic acid, Aspartame, stevia, saccharin, dipotassium glycyrrhizin, thaumatin, acesulfame, and the like. These specific ingredients are mentioned as mere examples, and the ingredients are not limited to these examples.

Examples of the composition are mentioned below. However, these compositions are mentioned as mere examples, and the types and amounts of ingredients used are not limited to these examples.

### COMPOSITION EXAMPLE 1

### Vitamin Subtilized Granules

| | | |
|---|---|---|
| Vitamin B₆ | 30 | mg |
| Vitamin B₂ | 3 | mg |
| Nicotinamide | 15 | mg |
| Crystalline calcium pantothenate of the present invention | 100 | mg |
| Hydroxypropylcellulose | 30 | mg |
| Lactose | 822 | mg |
| Total | 1000 | mg |

### COMPOSITION EXAMPLE 2

### Dog Food (Processed Product)

| | | |
|---|---|---|
| Breast meat of a chicken | 21 | g |
| Wheat flour | 42.95 | g |
| Soybean Protein | 9 | g |
| Glucose | 5 | g |
| Sodium chloride | 1 | g |
| Sorbic acid | 0.05 | g |
| Vitamin B₆ | 6 | g |
| Nicotinamide | 5 | g |
| Crystalline calcium pantothenate of the present invention | 10 | g |
| Total | 100 | g |

### COMPOSITION EXAMPLE 3

### Feed Premix for Animals

| | | |
|---|---|---|
| Vitamin K₃ | 0.2 | g |
| Folic acid | 0.2 | g |
| Vitamin B₆ | 20 | g |
| Vitamin B₁ | 16 | g |
| Biotin | 0.1 | g |
| Nicotinamide | 20 | g |
| Crystalline calcium pantothenate of the present invention | 18 | g |
| Manganese carbonate | 20 | g |
| Zinc sulfate | 12 | g |
| Iron sulfate | 5 | g |
| Rice bran | 888.5 | g |
| Total | 1000 | g |

The method provided from another aspect of the present invention is a method for preparing an aqueous solution of calcium pantothenate by adding an aqueous medium to calcium pantothenate, which is characterized by using the aforementioned crystalline calcium pantothenate obtained by the described method as the calcium pantothenate. The aforementioned crystalline calcium pantothenate can more finely be dispersed in water as compared with amorphous calcium pantothenate powder, and accordingly, a period of time required up to homogenous dissolution is shortened. Therefore, by using the aforementioned crystalline calcium pantothenate, working hours and working cost for addition of calcium pantothenate to an aqueous medium and successive dissolution can be remarkably reduced in a industrial manufacture of drip infusions and beverages.

The feed for animals provided from a still further aspect of the present invention is characterized to contain the aforementioned crystalline calcium pantothenate and a vitamin in a homogenously mixed state. The feed for animals of the present invention can be produced by the step of homogenously mixing the aforementioned crystalline calcium pantothenate in feed for animals containing a vitamin, or the step of homogenously mixing a vitamin and the aforementioned crystalline calcium pantothenate in feed for animals which contains substantially no vitamin or contain only a small amount of vitamin.

As the feed for animals, feed for livestock such as bovine, swine, horse and fowl can generally be used, and any feed ordinarily used in the stock raising industry such as dairy farming and poultry farming may be used. The amount of the crystalline calcium pantothenate to be added to the feed for animals is not particularly limited. The amount may generally be about 5 to 25 mg/kg (feed), and the amount of the vitamin is generally about 300 to 600 mg/kg (feed). As the vitamin, those explained above can be used. By using the crystalline calcium pantothenate of the present invention, a small amount of calcium pantothenate can be homogenously mixed in feed for animals, and thus the feed for animals of the present invention can be easily produced without formation of masses. When the feed for animals of the present invention is used, efficiency of dairy cow production can be markedly improved, for example, an amount of production of milk fat and proteins can be increased and days reaching to pregnancy can be shortened, because the feed contains a small but an appropriate amount of calcium pantothenate. In addition, the crystalline calcium pantothenate of the present invention can also be sprinkled on feed for animals as what is called top dressing.

### EXAMPLES

The present invention will be explained more specifically by referring to examples. However, the scope of the present invention is not limited to the following examples.

MultiFlex 2 kW (horizontal type goniometer, Rigaku Corporation) was used as an X-ray diffraction apparatus, and the following conditions were applied for the X-ray diffraction measurement.
X-ray tube target: Cu
Tube voltage: 40 kV
Tube current: 20 mA

Monochromatization of X-ray: monochromator method+PHA (pulse height analyzer, differentiation mode)

| | | |
|---|---|---|
| Slit: | Diverging slit | 1° |
| | Scattering slit | 1° |
| | Light-receiving slit | 0.15 mm |
| Sampling interval: | 0.02° | |
| Scanning velocity: | 5°/min | |

For the measurement, a sample exchanger (ASC-6A) was used, in which rotation number was set to be 60 rpm. As for a sample holder, 0.8 g of sample was filled in a penetration type sample plate, or a sample plate with a bottom (deep bottom type, depth: about 2 mm) was used. The total amount of the sample in a container for standing was transferred to a mortar, ground with a pestle until coarse particles totally disappeared, and filled in each sample holder according to the method described in the operation manual.

For the electron microscope observation, vapor-deposition was performed on the sample, and a scanning electron microscope was used. The setting magnification was about 200 times and about 2000 times.

For the measurement of physical properties of fine particles, Powder Tester Model PT-N produced by HOSOKAWA MICRON CORP. was used. Each measurement was performed 3 times by a general method according to the manual, and an average of the results was used.

Amorphous powder of calcium pantothenate was obtained by drying a calcium pantothenate aqueous solution with a spray dryer.

### Reference Example 1

### Preparation of β-Form Needles

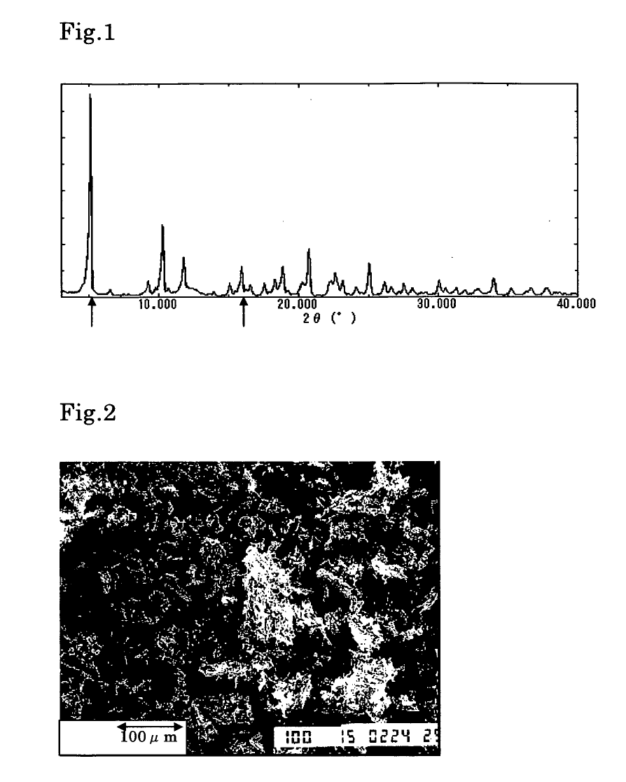

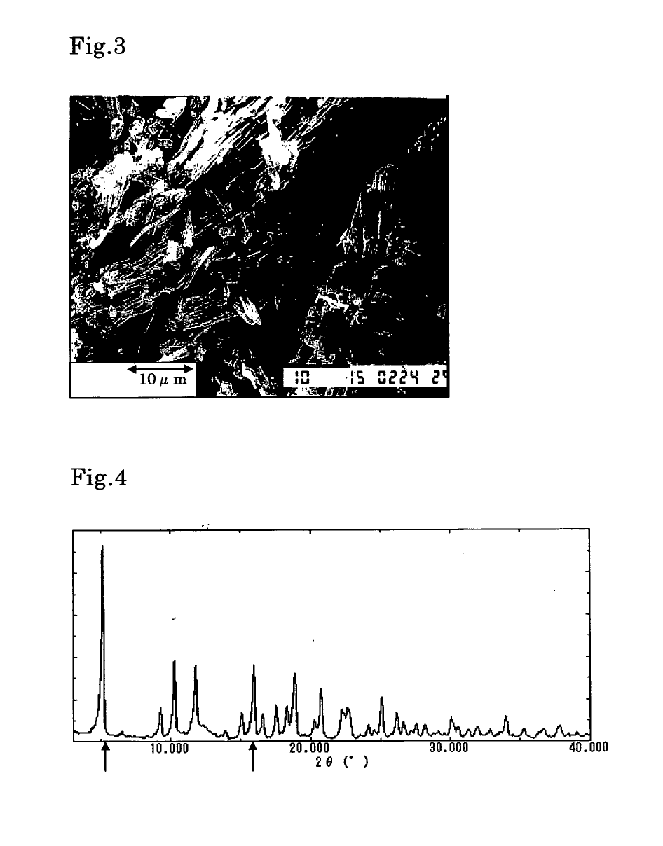

β-Form crystalline calcium pantothenate was obtained according to the method described by Inagaki et al. (Chem. Pharm. Bull., 24, pp. 3097-3102, 1976). 5 g of amorphous calcium pantothenate granules (manufactured by Daiichi Fine Chemicals, Inc.) was fully dissolved in 100 g of ethanol containing 10% by weight of water by sufficient stirring, and left standing at 25° C. After one day, the precipitated crystals were collected by filtration under reduced pressure and dried at room temperature under reduced pressure. When these crystals were analyzed by using the powder X-ray diffractometer, it was found that the diffraction intensity I^{5.1} at a diffraction angle (2 θ) of 5.1° was clearly larger than the diffraction intensity 16.0° at a diffraction angle (2 θ) of 16.0°, and this pattern was found to be identical with the powder X-ray diffraction pattern of the β-form crystal described by Inagaki et al. (Chem. Pharm. Bull., 24, pp. 3097-3102, 1976) (FIG. 1). It was also confirmed by electron microscopy of the crystals (FIGS. 2 and 3) that the crystals obtained were fine needles having a length of about 10 μm.

### Reference Example 2

### Large Amount Production of β-Form Needles

40 g of calcium pantothenate (amorphous powder) was added to 200 g of ethanol containing 10% by weight of water and homogenously dissolved at room temperature with applying ultrasonication. During the dissolution process, the solution sometimes became turbid because of start of partial precipitation. The aqueous suspension solution was stirred with warming at 40° C. Then, the precipitation progressed within several tens of minutes, and the suspension apparently became cloudy with rise of viscosity. The precipitated crystals were collected by filtration under reduced pressure while the suspension still maintained flowability, and the masses of the resulting crystals was crumbed and dried under reduced pressure at 40° C. for several hours by using an evaporator. The dried crystals were sized with light crush on a 150-μm sieve. In order to obtain a sufficient amount of crystals for measurement of physical properties of the powder, the aforementioned procedure was repeated 3 times to obtain 77 g in total of crystals.

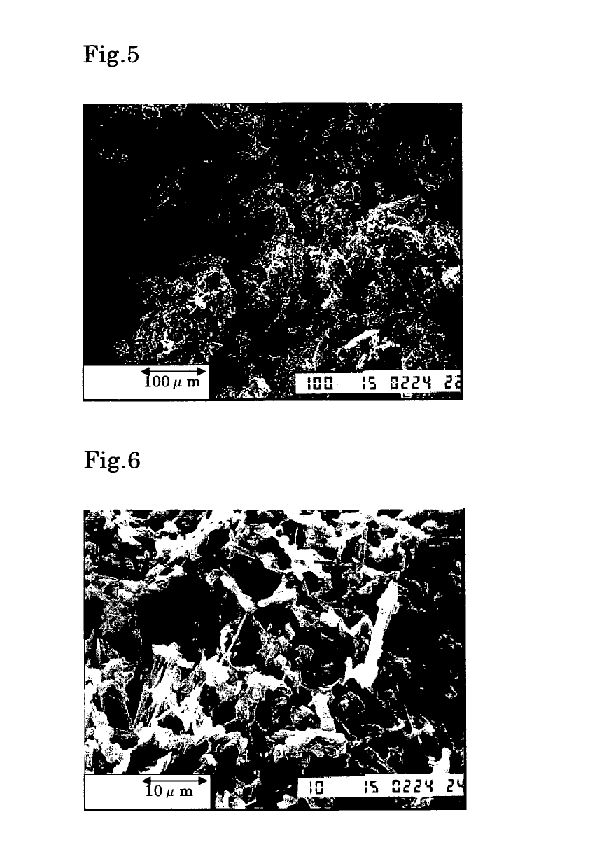

The crystals passed through the sieve were analyzed by powder X-ray diffractometry, and as a result, the diffraction pattern was found to identical with the diffraction pattern described by Inagaki et al. (Chem. Pharm. Bull., 24, pp. 3097-3102, 1976) (FIG. 4) where I^{5.1} was clearly larger than I^{16.0}, which was the same as that of the crystals obtained in Reference Example 1. By observation of appearance by electron microscopy (FIGS. 5 and 6), it was also confirmed that the crystals obtained were fine needles having a length of about 10 μm in the same manner as above.

### Reference Example 3

### Manufacture of Amorphous Calcium Pantothenate

An aqueous solution of calcium pantothenate was dried by using a spray dryer to obtain amorphous calcium pantothenate. The moisture content of the resulting amorphous calcium pantothenate was found to be 2 to 3% (Karl Fischer method), and no substantial peak was observed in the powder X-ray diffractometry.

### Reference Example 4

### Manufacture of Novel Crystalline Calcium Pantothenate

1 g of the β-form crystals obtained from the water-containing ethanol solution were sufficiently mixed with 1 g of the amorphous powder of calcium pantothenate obtained in Reference Example 2. The resulting mixture was thinly spread on a vat under an environment of 60° C. and 50% RH, and left standing for 7 hours or more to obtain fine particles whole of which became crystalline calcium pantothenate. The fine particles obtained sometimes slightly solidified. The solidified masses were disintegrated on a 150-μm sieve for sizing in the same manner as in Reference Example 2.

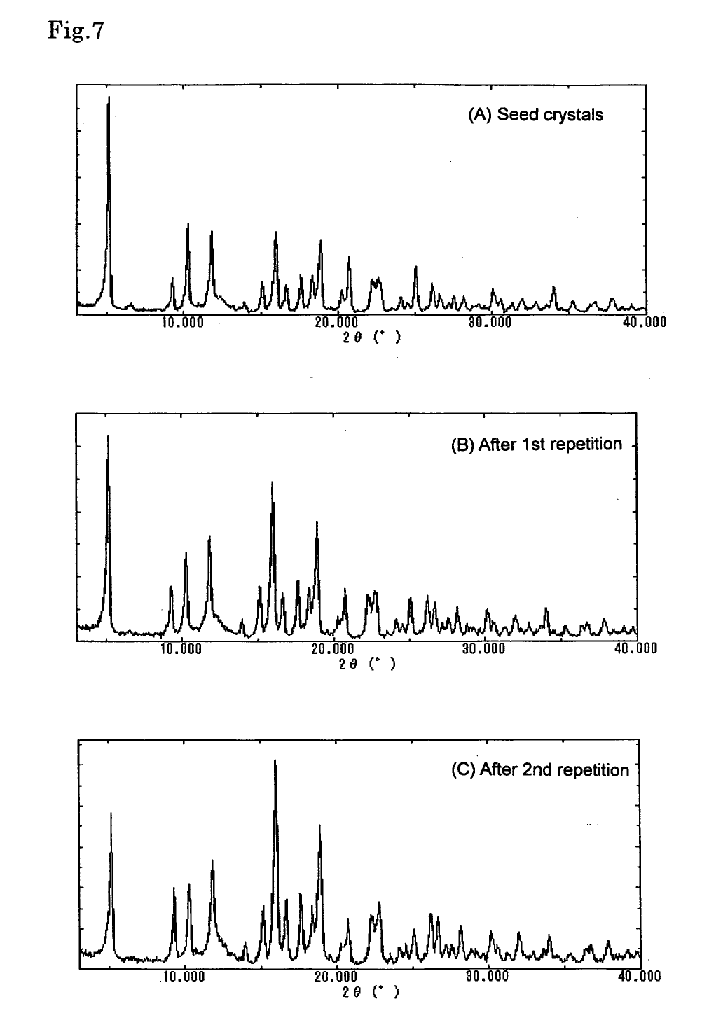

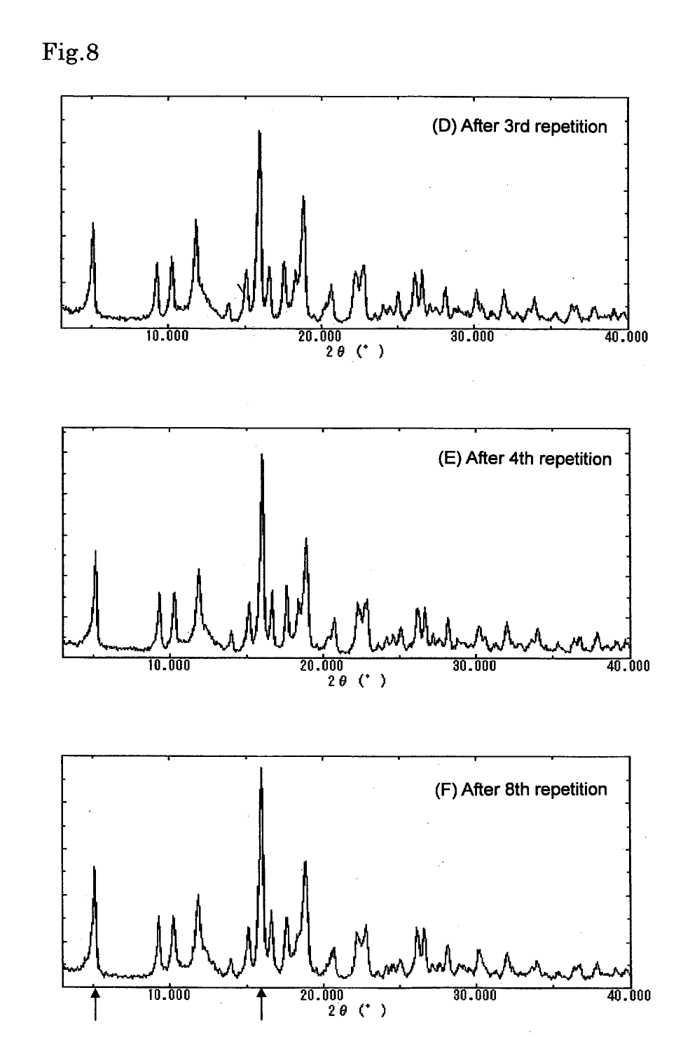

The resulting crystalline calcium pantothenate was again sufficiently mixed with the same volume of the amorphous powder of calcium pantothenate, thinly spread on a vat under an environment of 60° C. and 50% RH, and left standing for 7 hours or more in the same manner as described above to obtain fine particles in which entire particles became crystalline calcium pantothenate. This operation was repeated 8 times in total to obtain about 230 g of crystalline calcium pantothenate. Powder X-ray diffraction charts of the β-form crystals as originally used in this procedure, the crystalline calcium pantothenate obtained after the first operation, the crystalline calcium pantothenate obtained after the second operation, the crystalline calcium pantothenate obtained after the third operation, the crystalline calcium pantothenate obtained after the fourth operation, and the crystalline calcium pantothenate obtained after the eighth operation are shown in FIGS. 7 and 8.

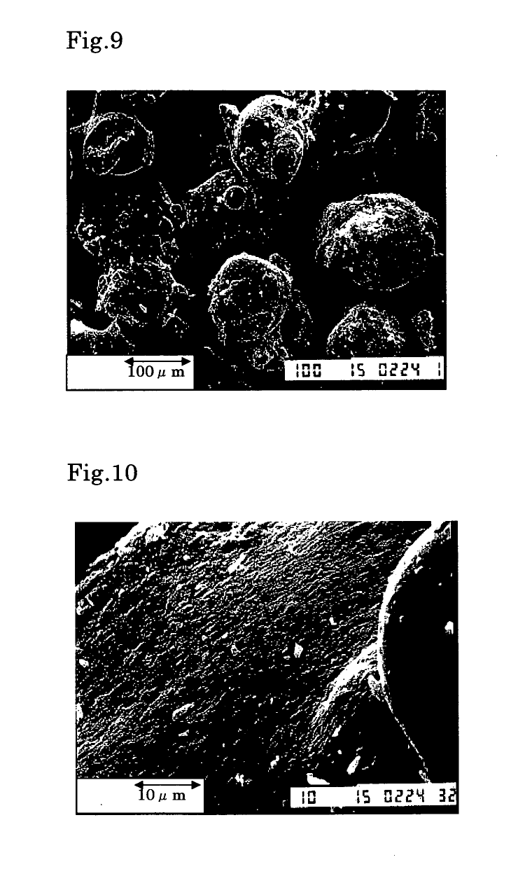

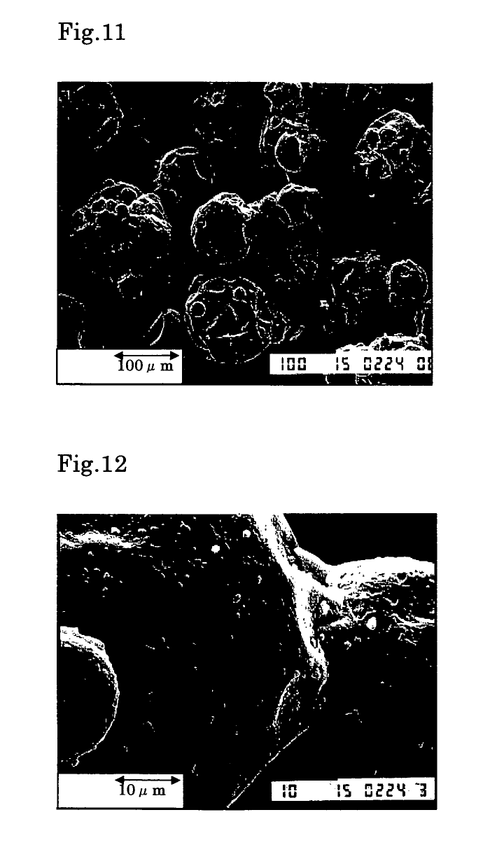

It was observed that, by repeating the operation of mixing and moisture absorption, the diffraction intensity I^{5.1} at a diffraction angle (2 θ) of 5.1° relatively decreased, and the diffraction intensity I^{16.0} at a diffraction angle (2 θ) of 16.0° relatively increased, and in the crystalline calcium pantothenate finally obtained by the eighth operation, the ratio (I^{16.1}/I^{5.1}) of I^{5.1} at a diffraction angle (2 θ) of 5.1° and the diffraction intensity I^{16.0} at a diffraction angle (2 θ) of 16.0° was about 1.9. As clearly shown by the electron micrographs of the crystalline calcium pantothenate obtained by the eighth operation (FIGS. 9 and 10), the resulting crystalline calcium pantothenate was found to contain almost no needles having angles unique to crystals with a size of several tens of micrometers or more, and have appearance similar to that of the amorphous powder as the starting material (FIGS. 11 and 12).

### Test Example 1

By using the crystalline calcium pantothenate (crystalline PC) obtained in Reference Example 4, a composition was prepared according to the following formulation 1. This composition was placed in a glass bottle and left standing for two weeks under the conditions of 25° C. and 60% RH without plug. After two weeks, calcium pantothenate and ascorbic acid contents of the mixed powder were measured. For comparison, a comparative composition was prepared by using the amorphous calcium pantothenate (amorphous PC) obtained in Reference Example 3 according to the following formulation 1, and similarly examined. The results are shown in Table 1 (the contents mentioned in the table are remaining ratios). As clearly shown by the results set out in Table 1, when the crystalline calcium pantothenate obtained in Reference Example 4 was used with ascorbic acid, remarkable improvement of the stability of calcium pantothenate was observed compared with the composition using the amorphous calcium pantothenate.

<Formulation 1>

| | |
|---|---|
| Calcium pantothenate | 1 g |
| Ascorbic acid | 1 g |
| Total | 2 g |

TABLE 1

| | After two weeks at 25° C. and 60% RH | |
|---|---|---|
| | Calcium pantothenate | Ascorbic acid |
| Component | content | content |
| Crystalline PC: ascorbic acid | 97.7% | 94.3% |
| Amorphous PC: ascorbic acid | 91.5% | 94.6% |

### Test Example 2

By using the crystalline calcium pantothenate obtained in Reference Example 4, a composition was prepared according to the following formulation 2. This composition was placed in a glass bottle and left standing for two weeks under the conditions of 40° C. and 75% RH without a seal. After two weeks, calcium pantothenate and calcium ascorbate contents of the mixed powder were measured. For comparison, a comparative composition was prepared by using the amorphous calcium pantothenate obtained in Reference Example 3 according to the following formulation 2, and similarly examined. The results are shown in Table 2 (the contents mentioned in the table are remaining ratios). As clearly shown by the results set out in Table 2, when the crystalline calcium pantothenate obtained in Reference Example 4 was used with calcium ascorbate, calcium pantothenate was more stable compared with the composition using the amorphous calcium pantothenate. Moreover, when the crystalline calcium pantothenate obtained in Reference Example 4 was used, calcium ascorbate was more stable compared with the composition using the amorphous calcium pantothenate.

<Formulation 2>

| | |
|---|---|
| Calcium pantothenate | 1 g |
| Calcium ascorbate | 1 g |
| Total | 2 g |

TABLE 2

| | After two weeks at 40° C. and 75% RH | |
|---|---|---|
| | Calcium | Calcium ascorbate |
| Component | pantothenate content | content |
| Crystalline PC: calcium | 98.4% | 101.2% |
| ascorbate | | |
| Amorphous PC: calcium | 93.6% | 95.6% |
| ascorbate | | |

### Test Example 3

By using the crystalline calcium pantothenate obtained in Reference Example 4, the vitamin premix shown in Table 3 was prepared, and the stability of each vitamin was examined. The storage conditions are shown in Table 4. For comparison, a composition was prepared according to the same formulation by using the amorphous calcium pantothenate obtained in Reference Example 3, and stability of each vitamin was examined. The results are shown in Table 5 (the contents mentioned in the table are remaining ratios). As clearly shown by the results set out in Table 5, when the crystalline calcium pantothenate obtained in Reference Example 4 was used, vitamin B₆ and vitamin B₁ were more stable compared with the composition where the amorphous calcium pantothenate obtained in Reference Example 3 was used.

TABLE 3

| Component | Amount | | Note |
|---|---|---|---|
| Vitamin A palmitate | 2 | g | |
| Vitamin D₃ | 0.08 | g | |
| Vitamin E | 16 | g | ROVIMIX E |
| Vitamin B₁₂ | 0.04 | g | |
| Vitamin B₂ | 4 | g | |
| Nicotinamide | 24 | g | |
| Vitamin K₃ | 0.24 | g | |
| Folic acid | 0.8 | g | |
| Vitamin B₆ | 1.236 | g | |
| Vitamin B₁ | 13.2 | g | |
| Biotin | 0.08 | g | |
| Calcium pantothenate | 74.16 | g | Crystalline PC or amorphous PC |
| Sodium | 1.472 | g | |
| dihydrogenphosphate | | | |
| Manganese carbonate | 16.732 | g | |
| Iron citrate | 21.044 | g | |
| Copper sulfate | 20 | g | |
| Cobalt sulfate | 0.212 | g | |
| Potassium iodide | 0.524 | g | |
| Total | 195.82 | g | |

TABLE 4

| Storage condition | Storage container | Storage period |
|---|---|---|
| 25° C., 60% RH | Glass bottle, no plug | 30 days |

TABLE 5

| | 25° C., 60% RH, 30 days | |
|---|---|---|
| | Crystalline PC was used | Amorphous PC was used |
| Calcium | 98.6% | 97.3% |
| pantothenate | | |
| Vitamin B₆ | 99.3% | 92.8% |
| Vitamin B₁ | 98.6% | 79.0% |

### Test Example 4

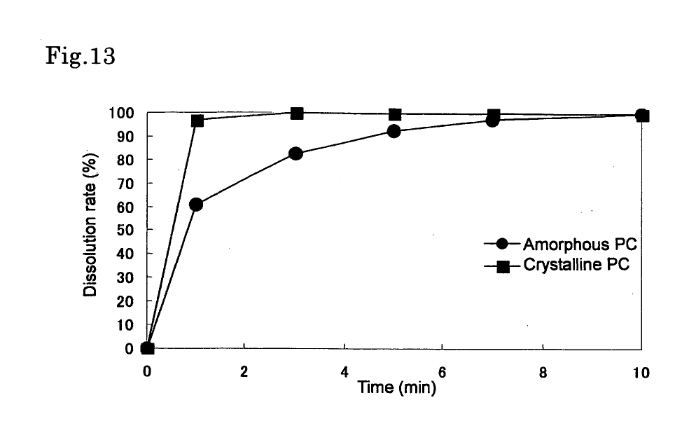

Dissolution properties of the crystalline calcium pantothenate obtained in Reference Example 4 and the amorphous calcium pantothenate obtained in Reference Example 3 were examined according to the dissolution test of Japanese pharmacopoeia and the results were compared. Conditions for the dissolution test are shown in Table 6. The results are shown in FIG. 13 and Table 7. As clearly shown by these results, the dissolution property of the crystalline calcium pantothenate obtained in Reference Example 4 was superior to that of the amorphous calcium pantothenate obtained in Reference Example 3.

TABLE 6

| Item | Condition |
|---|---|
| Test method | The second method (paddle method) |
| Test medium | Water |
| Test fluid volume | 900 mL |
| Fluid temperature | 25 ± 0.5° C. |
| Revolution number | 50 rpm |
| Charged sample amount | 0.9 g |

TABLE 7

| Time | Crystalline PC | Amorphous PC |
|---|---|---|
| After 1 minute | 96.7% | 60.9% |
| After 3 minutes | 100.0% | 82.6% |
| After 5 minutes | 100.0% | 92.8% |
| After 7 minutes | 100.0% | 97.6% |
| After 10 minutes | 100.0% | 99.9% |

### Test Example 5

The cows used for the test were balanced between the groups by parity and previous lactation 305d ME (305 days mature equivalent). Control group: cows were fed with standard pre- and postpartum diets fed to Spruce Haven Farm dairy cows. The compositions are shown in Tables 8 and 9 mentioned below.

Calcium pantothenate administered group: cows were fed with the same diets as the control group except that 6 g/cow/day of calcium pantothenate was added to the standard diets. Calcium pantothenate produced by the same method as that of Reference Example 4 mentioned above was used.

The experimental feed was administered in an amount of 0.23 kg/cow/day by mixing the same in cornmeal carrier. A given amount of the experimental feed was added to the TMR (Total Mixed Ration, completely mixed feed) once daily based on the number of cows in the administered group.

The animals were separately bred in either the control or calcium pantothenate administered group starting 21 days before estimated calving date to about 160 days in the subsequent lactation. Approximately 100 cows were assigned to each group to perform the experiment. Among the cows, about ⅓ were first-calf heifers and ⅔ were multiparous cows, and at least 80 cows per group that were eligible to be bred were secured at the completion of this test.

TABLE 8

| | |
|---|---|
| Dry | Lactating |

% Dry Matter

| | | |
|---|---|---|
| Haylage | 53.7 | 6.8 |
| Corn silage | 28.9 | 44.7 |
| Corn meal (fine grd) | 9.1 | 16.8 |
| Cho-sugar mix | — | 3.4 |
| Cottonseed w/lint | — | 3.5 |
| Corn distillers | 1.32 | 0.8 |
| Corn gluten meal | .41 | 1.00 |
| Fishmeal | — | 0.39 |
| Blood meal | .83 | 0.59 |
| Calcium carbonate | .32 | 1.39 |
| Soy Plus | 1.02 | 2.9 |
| Soybean meal | 2.26 | 9.76 |
| Soybean roasted | — | 3.63 |
| Potassium carbonate | — | 0.24 |
| Dynamate | .02 | 0.07 |
| Magnesium oxide | .62 | 0.34 |
| Salt | .02 | 0.67 |
| Megalac | — | 0.77 |
| Amax Yeast | — | 0.23 |
| Sodium bicarbonate | — | 0.7 |
| Calcium sulfate | 0.1 | 0.2 |
| Novasil | — | 0.45 |
| Monocal Phos 21 | .78 | 0.26 |
| Urea | .21 | 0.14 |
| ADE Premix* | .28 | 0.12 |
| Vit E 20000 | .09 | 0.07 |
| Selenium 270 | — | 0.05 |
| Zinc sulfate | .007 | 0.021 |
| Manganese sulfate | .0062 | 0.0065 |
| Copper sulfate | .0053 | 0.0063 |
| Cobalt sulfate | .00003 | 0.00004 |

*Premix containing only vitamin A, vitamin D and vitamin E.

TABLE 9

| | |
|---|---|
| Dry | Lactating |

% Dry Matter

| | | |
|---|---|---|
| Dry matter, % | 34.6 | 48.1 |
| Crude protein, % | 15.9 | 18 |
| Undegraded, % of CP | 28.2 | 40.7 |
| Degraded, % of CP | 71.8 | 59.3 |
| Soluble, % of CP | 50.2 | 31.8 |
| NEL* (Mcal/kg) | 1.56 | 1.76 |
| NDF**, % | 43.3 | 30.7 |
| Total fat, % | 3.4 | 5.01 |
| Calcium | 1.52 | 1.07 |
| Phosphorus | 0.46 | 0.42 |
| Magnesium, % | 0.62 | 0.41 |
| Potassium | 1.68 | 1.36 |
| Sulfur | 0.21 | 0.23 |
| Sodium, % | 0.03 | 0.49 |
| Chloride, % | 0.03 | 0.45 |
| Zinc, ppm | 25.3 | 58 |
| Copper, ppm | 13.14 | 12 |
| Manganese, ppm | 18.09 | 15 |
| Selenium, ppm | 0.31 | 0.31 |
| Cobalt, ppm | 0.12 | 0.09 |
| Iodine, ppm | 0.91 | 0.9 |
| Vitamin A, KIU***/kg | 20.2 | 11.8 |
| Vitamin D, KIU***/kg | 6.74 | 2.62 |
| Vitamin E, IU***/kg | 114.4 | 37.0 |

*Net Energy of Lactation
**Net Detergent Fiber
***(Kilo) International Unit (international unit for vitamins)

As the cows were assigned to the dry period, the cows of each group received the designated assigned feeding. The cows were milked twice a day, and milk production was recorded on a monthly basis, and evaluated on the basis of DHI (Dairy Herd Improved Association) statistics. Milk compositions were collected every Monday P.M and Tuesday A.M. during the trial duration. The determination of milk protein, fat, milk urea nitrogen (MUN), lactose and somatic cell in the milk compositions was conducted. Body weight and condition scores were recorded at calving and again at the end of the test. Metabolic and infectious diseases measured were listed and defined as follows:

Retained Placenta: a placenta that had been retained for >24 hours.

Metritis: a uterine condition diagnosed by either vaginal discharge and/or rectal palpation by a veterinarian, usually associated with a rectal temperature of >39.4° C. (103° F.).

Ketosis: a metabolic state whereby ketones were detected either in the milk or urine at a high level, and therapy included various combinations of intravenous injections of glucose, gluccocorticoids, or oral administration of propylene glycol.

Displaced Abomasum: diagnosed as gas accumulation as detected by percussion with a stethoscope either on the left or right side. Surgery or blind stitch tacks were performed on these cows to correct the displacement.

Reproductive indices measurement: reproductive indices measured included days to first heat, days to first breeding, days open, services per conception. Additionally, other parameters included first-service conception, cows pregnant by 100 days, 150 days, and trial end.

Statistical analysis for production parameters: statistical analysis for production parameters was conducted by SAS JMP utilizing a split-plot-in-time analysis of variance for repeated measures. The model utilized was as follows: μ=mean+trt (treatment)+month+cow (trt: treatment)+month×trt (treatment)+residual error. Survival analysis were conducted on some reproductive parameters, which were “time to event” measurements including days to first heat and days open, using Chi square log rank test for estimating the relative difference between treatments. Data with dichotomous outcomes such as pregnant at first service, pregnant by 100 days, 150 days and end of study as well as health data were analyzed by logistic regression procedure of SAS JMP.

The effects of calcium pantothenate supplementation on milk production performance of dairy cows are shown in Table 10. Milk production was not significantly influenced by calcium pantothenate supplementation. However, cows receiving calcium pantothenate produced 0.5 kg more than the control. The 3.5% fat-corrected milk (3.5 FCM) was higher (P=0.01) for cows consuming calcium pantothenate compared to the control (38.9 vs. 37.4 kg respectively). This difference was primarily influenced by a higher (P=0.02) fat test for cows receiving calcium pantothenate (3.65 vs. 3.51% for calcium pantothenate and control cows, respectively). This resulted in an increased fat yield (P=0.01) for cows receiving calcium pantothenate. Protein percentage was not influenced by calcium pantothenate supplementation. However, yield of protein was higher (P=0.02) for cows receiving calcium pantothenate. There was no effect of calcium pantothenate supplementation on lactose concentration, milk urea nitrogen, or somatic cell concentration in the milk. Body weight or condition score was not influenced by calcium pantothenate supplementation.

TABLE 10

Treatments

| Variable | Control | PanCal | SEM | P = |
|---|---|---|---|---|
| N¹ | 83 | 85 | | |
| Milk, kg | 37.9 | 38.4 | 0.4 | 0.39 |
| 3.5 FCM, kg | 37.4 | 38.9 | 0.4 | 0.01* |
| Fat, % | 3.51 | 3.65 | 0.04 | 0.02* |
| Fat, kg | 1.28 | 1.38 | 0.02 | 0.01* |
| Protein, % | 3 | 3.04 | 0.03 | 0.29 |
| Protein, kg | 1.11 | 1.15 | 0.02 | 0.02* |
| Lactose, % | 4.73 | 4.74 | 0.01 | 0.76 |
| MUN | 12.1 | 11.7 | 0.12 | 0.17 |
| SCC, X1000 | 110 | 119 | 9 | 0.47 |

¹Cows had to have at least 2 months of production data to be included in the production data set.

TABLE 11

Treatments

| | Control | PanCal | SEM | P = |
|---|---|---|---|---|
| N | 81 | 82 | | |
| Body Wt (kg) | | | | |
| Initial | 674 | 669 | 9 | .69 |
| Final | 657 | 656 | 9 | .92 |
| Change | −17 | −13 | | |
| Body Condition Score | | | | |
| Initial | 3.54 | 3.51 | .02 | .38 |
| Final | 3.38 | 3.37 | .03 | .56 |
| Change | −.16 | −.14 | | |

The effects of calcium pantothenate supplementation on health disorders are listed in Table 12. All cows included in this analysis were those that had at least 21 days on the post-lactation treatment regime. The incidence of diseases reported were similar between the groups and within the normal range of those found for this size dairy. Cows included in the reproductive analysis were those which completed the test, and no abnormality was observed through the end of the experimental period (Table 12).

TABLE 12

| Variable | Control | PanCal | P = |
|---|---|---|---|
| N¹ | 88 | 93 | |
| | % (number) incidences | | |
| Twins | 5.7 (5) | 4.3 (4) | |
| Retained Placenta | 11.3 (10) | 9.7 (9) | .81 |
| Metritis | 21.5 (19) | 22.6 (21) | .63 |
| Ketosis | 11.3 (10) | 12.9 (12) | .77 |
| Displaced Abomasum | 5.7 (5) | 5.4 (5) | .65 |

¹Included cows that calved and had at least 21 days in the treatment group

There were no differences in days to first heat for cows that became pregnant during the trial period, and days to first breeding was similar between the groups. Days open was lower (P=0.1) for cows receiving calcium pantothenate as compared to the control cows. Services per conception were similar between the groups. Of the cows eligible to be bred, cows being fed with calcium pantothenate had similar percent of cows pregnant on first service and pregnant by 100 days compared to the control cows. However, cows receiving calcium pantothenate had 76.9% (P=0.03) of the cows that were eligible to breed pregnant by 150 days, whereas the control cows only had 61.3%. By the end of the test, 82.1% of the cows receiving calcium pantothenate became pregnant compared to 76.3% for cows in the control group. The above results show that administration of calcium pantothenate reduces the number of days to pregnancy and provides a greater percentage of cows pregnant by 150 DIM (Days In Milk).

TABLE 13

| | Control | PanCal | SEM | P = |
|---|---|---|---|---|
| N¹ | 61 | 64 | | |
| Days to first heat | 55.3 | 58.9 | 1.4 | 0.33 |
| Days to first breeding | 63.9 | 64.1 | 0.4 | 0.87 |
| Days open | 95.6 | 88.7 | 4.3 | 0.10* |
| Services/conception | 1.67 | 1.64 | 0.11 | 0.83 |
| N² | 80 | 78 | | |
| Pregnant on first service, % | 43.8 | 46.2 | | 0.75 |
| Pregnant by 100 d, % | 45 | 46.2 | | 0.90 |
| Pregnant by 150 d, % | 61.3 | 76.9 | | 0.03* |
| Pregnant by end of treatment period, % | 76.3 | 82.1 | | 0.37 |

¹based on cows that were confirmed pregnant, which were bred through 170 postpartum (Survival Analyses).
²based on cows that finished trial period (170 days postpartum) that were eligible to breed but did not become pregnant (Odds ratio/Logistic regression Analyses).

1. A composition containing calcium pantothenate and at least one kind of vitamin as a mixture in a solid state, wherein the calcium pantothenate is crystalline calcium pantothenate obtainable by a method comprising the following steps:
(1) step of mixing crystalline calcium pantothenate and amorphous calcium pantothenate to prepare a homogenous mixture;
(2) step of allowing the homogenous mixture obtained in the aforementioned step (1) to absorb moisture to prepare crystalline calcium pantothenate; and
(3) step of repeating the aforementioned steps (1) and (2) by using the crystalline calcium pantothenate obtained in the aforementioned step (2).

2. The composition according to claim 1, wherein the crystalline calcium pantothenate is crystalline calcium pantothenate showing peaks in a powder X-ray diffraction spectrum at the positions of diffraction angles (2θ) of 5.1°, 10.3°, 11.9°, 16.0°, and 18.9°, and the ratio (I^{16.0}/I^{5.1}) of the diffraction intensity at an diffraction angle (2θ) of 16° relative to the diffraction intensity at an diffraction angle (2θ) of 5.1° is 1 or more.

3. The composition according to claim 1, which is selected from the group consisting of a pharmaceutical composition, processed food, animal feed, and cosmetic composition.

4. The composition according to claim 1, wherein the vitamin is a water-soluble vitamin.

5. The composition according to claim 4, wherein the water-soluble vitamin is ascorbic acid or a salt thereof.

6. A method for enhancing, in a composition containing calcium pantothenate and at least one kind of vitamin as a mixture in a solid state, stability of the calcium pantothenate and/or the vitamin, wherein crystalline calcium pantothenate obtainable by the method according to claim 1 is used as the calcium pantothenate.

7. A method for preparing an aqueous solution of calcium pantothenate by adding an aqueous medium to solid calcium pantothenate in a dry state, wherein the calcium pantothenate is crystalline calcium pantothenate obtainable by the method according to claim 1.

8. Crystalline calcium pantothenate obtainable by the method according to claim 1, which is used for preparing an aqueous solution containing calcium pantothenate.

9. Feed for animals containing the crystalline calcium pantothenate according to claim 1 and a vitamin in a homogenously mixed state.

10. A method for producing feed for animals, which comprises the step of homogenously mixing the crystalline calcium pantothenate according to claim 1 in feed for animals containing a vitamin.

11. A method for producing feed for animals, which comprises the step of homogenously mixing a vitamin and the crystalline calcium pantothenate according to claim 1 in feed for animals.

12. Feed for breeding bovines, which contains the crystalline calcium pantothenate according to claim 1 and a vitamin in a homogenously mixed state, and can increase an amount of production of milk fat and proteins and/or can shorten days to pregnancy.
